(19) United States
(12) Patent Application Publication
(10) Pub. No.: US 2007/0181723 A1
(43) Pub. Date: Aug. 9, 2007

(54) Disc mill

(76) Inventors: Karlheinz Herbold, Meckensheim (DE); Holger Watzelt, Neckargemund-Dilsberg (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/596,629

(22) PCT Filed: Dec. 13, 2004
(86) PCT No.: PCT/DE04/02727

§ 371 Date: Mar. 27, 2007

(30) Foreign Application Priority Data
Dec. 19, 2003 (DE) 103 60 618.1
Jan. 13, 2004 (DE) 10 2004 001 976.2

(51) Int. Cl. B02C 1/08

(52) U.S. Cl. 241/253

(57) ABSTRACT

The invention relates to a disc mill having two substantially parallel grinding discs (2, 3) that are configured as annular discs having a center passage (4) and that have opposite working surfaces (9, 10). These working surfaces are spaced apart from each other, thereby forming a working chamber (11) in the area of the passage (4), and converge outwards, thereby tapering the working chamber, and rotate in relation to each other. The inventive disc mill is characterized in that the working surfaces (9, 10), in an outer edge section (12), are configured in parallel and with an at least slight distance to each other.

### BACKGROUND

The invention relates to a disk mill with two grinding disks which are each formed as a ring with a central hole, are disposed so as to be essentially parallel to one another, rotate with respect to one another, and comprise working surfaces which are directed towards one another, are spaced apart from one another thereby forming a working space in the area of the hole, run towards one another in the outwards direction, and narrow the working space.

Disk mills of the most varied types of construction have been known from practice for many years. Merely by way of example, reference is made to DE 102 03 752 C1, from which a generic disk mill, in particular the grinding disk configuration there, is known. In the generic disk mill one grinding disk is disposed in such a manner that it cannot rotate and the other grinding disk is disposed in such a manner that it can rotate so that a rotating motion of both grinding disks with respect to one another can be realized.

Specifically, grinding stock previously reduced to small pieces or in the form of a granulate is ground to form a fine-grain or powdered product, where the grinding stock is introduced into the working space formed by the grinding disks. Due to the centrifugal forces transmitted to the grinding stock during the rotation of one of the grinding disks, this stock is conveyed in the outwards direction and due to the working space narrowing in the outwards direction is comminuted further.

The grinding stock can be a product of any type, in particular plastics, above all however products or materials in the field of foodstuffs.

The generic disk mill is however problematic to the extent that since the grinding process defining the resulting grain/powder size occurs only in the outer area of the grinding disk. Due to the working space always becoming narrower in the outwards direction, said working space ending with a linear annular gap between the grinding disks, the dwell time of the grinding stock in the area predefining the final grain size is extremely small. Accordingly, the grinding process lasts a long time or the result of grinding is unsatisfactory, in particular with regard to a homogeneous fraction and also with regard to the achievable fineness of the grinding stock.

The objective of the present invention is thus to develop and extend a disk mill of the generic type in such a manner that along with small grain size a sufficiently good result of grinding can be realized with the simplest construction of the grinding disks.

### BRIEF SUMMARY OF THE PRESENT INVENTION

The objectives above and others are realized by providing a disk mill, the disk mill comprising two grinding disks each formed as a ring with a central hole, with the disks being disposed so as to be essentially parallel to one another, and rotatable with respect to one another about a common axis which extends through the central holes of the disks, and which comprise first working surfaces in an inner area which are directed towards one another, are spaced apart from one another thereby forming a working space in the area adjacent the hole, run conically towards one another in the outwards direction, and narrow the working space; and second working surfaces formed in an outer edge section so as to be parallel to one another and with at least slight spacing from one another, wherein the first working surfaces as well as the second working surfaces are provided with straight cutting teeth, wherein the cutting teeth have an approximately saw-tooth cross section, wherein the cutting teeth of the first and second working surfaces of the same grinding disk run in the same direction obliquely to the radial direction, and wherein the cutting teeth of the second working surfaces are inclined more sharply than the cutting teeth of the first working surfaces.

According thereto, the generic disk mill is developed and extended in such a manner that the working surfaces are formed in an outer edge section so as to be parallel to one another and with at least a slight spacing from one another. In other words, the area between the two grinding disks, which is formed as an annular gap in the state of the art, is extended quite significantly, namely by the fact that this area is formed as a flat surface and with the slightest spacing of the grinding disks from one another, namely by the fact that the working surfaces, over a not inconsiderable area with the slightest spacing from one another, define a type of circular, flat-surface gap through which the grinding stock is pressed due to centrifugal forces applied and in so doing is sufficiently comminuted. Through the particular configuration of the outer edge section with the working surfaces formed so as to be parallel to one another the dwell time of the grinding stock in the narrowest area between the grinding disks is lengthened, whereby the result of the grinding is enhanced quite significantly.

In particular with regard to simple construction, one of the two grinding disks is disposed in such a manner that it cannot rotate and the other grinding disk is disposed in such a manner that it can rotate, whereby a rotating motion of the two grinding disks with respect to one another results. However, it is also conceivable that the two grinding disks rotate counter to one another, i. e. rotate in opposite directions with respect to one another, and it is also conceivable that the rotation of the rotating grinding disks can take place in the same direction at different speeds.

In particular in the scope of a particularly simple development the grinding disks are of the same size and disposed so as to be coaxial with one another. However, using grinding disks of different sizes is also conceivable, where between the grinding disks the working space is formed in accordance with the explanations above. An eccentric disposition of both grinding disks is also conceivable whether they are of the same size or of different sizes.

In particular with regard to simple construction and production of the grinding disks, the idea presents itself that the edge section enclosing the working surfaces running parallel to one another is formed as a ring so that it is defined as an encircling edge with working surfaces running parallel to one another. This edge section can be dimensioned with different widths, where an edge section comprising 30% to 70% of the radial extension of the grinding disk has proven itself to be sufficiently good with respect to the result of the grinding.

At this point let it be noted that in the manner according to the invention it is a matter of lengthening the dwell time in the outermost area of the working space between the grinding disks. Such a lengthened dwell time is achieved by the fact that the narrowest area between the grinding disks in the edge section is enlarged around the circumference, namely by the working spaces being formed there so as to be parallel to one another and with the slightest spacing from one another. In contradistinction to the linear annular gap defined in the state of the art, in the manner according to the invention a flat-surface annular gap is provided which enhances the result of grinding from any point of view.

It has already been explained previously that the working space narrowing in the outwards direction is formed by the working surfaces of the grinding disks. In the area of the working space it is of further advantage if the working surfaces run conically towards one another. Furthermore, such a configuration promotes simple manufacture of the grinding disks.

The result of grinding is further enhanced if the working surface of at least one grinding disk is provided with cutting teeth, and in fact preferably the working surface of the rotating grinding disk. An additional improvement of the result of grinding is achieved when the working surfaces of both grinding disks have cutting teeth.

In principle it is possible that the working surfaces are all provided with cutting teeth which act directly on the grinding stock. This means that in particular the working surfaces running towards one another also have cutting teeth. The same holds for the working surfaces running parallel to one another between which the grinding stock is pressed due to centrifugal forces occurring. Cutting teeth formed there increase the dwell time yet again and improve the result of grinding. In an advantageous manner, the cutting teeth are formed in the area of the working surfaces running conically towards one another as well as in the area of the working surfaces running parallel to one another, whereby a sufficiently good result of grinding can be realized with a simple construction.

The cutting teeth themselves can be formed in some areas as singular projections for reducing the grinding stock to small pieces with corresponding cutting action. Also, it is possible that the cutting teeth have a longitudinal extension running from the inner edge to the outer edge. Along with this, the cutting teeth can have the most varied cross-sectional forms. In a particularly advantageous manner, the cutting teeth have an approximately saw-tooth cross section whose blade or cutting edge points in the direction of motion. On the opposite grinding disk the cutting teeth can point in the opposite direction so that an additional enhancement of the grinding process is also realized here.

Corresponding to the explanations above, the working space is subdivided into two areas by the working surfaces directed towards one another, namely into an inner area for receiving the grinding stock, said inner area narrowing in the outwards direction and into an outer circular edge section with working surfaces running parallel to one another which serves to lengthen the dwell time of the grinding stock in the narrowest area between the grinding disks. Both areas can be provided with cutting teeth according to the explanations above, where the cutting teeth can extend from the inner edge to the outer edge and in fact preferably in a straight line.

Thus it is possible in principle that the cutting teeth run approximately in the radial direction and in so doing tear the grinding stock during the operation of the grinding disks and thereby comminute on the path outwards. In a quite particularly advantageous manner, the cutting teeth are aligned so as to be oblique to the radial direction, where with an inclination towards the inner side the dwell time in the working space is lengthened yet again. Accordingly, the cutting teeth can be aligned in the area of the working surfaces running parallel to one another.

Furthermore, it is possible to dispose the cutting teeth in the area of the working surfaces running conically towards one another, i. e. within the narrowing working space, at a different angle than in the area of the working surfaces running parallel to one another. In so doing, account could be taken of a different absolute speed in the respective areas.

Experiments have shown that it is possible in principle to have the cutting teeth run at an angle of 2° to 40° to the radial direction in order to achieve a sufficiently good result of grinding and in fact as a function of the particular grinding stock. As has already been said previously, the cutting teeth can extend in a straight line from the interior in the outwards direction or with a different angular arrangement run with a deflection, where the possibility presents itself that the cutting teeth running in a straight line extend so that they run parallel to one another or in the manner of a fan.

In reference to particular applications of the disk mill according to the invention, let it be noted that it can be used for grinding harder as well as softer materials, namely with the adaptation of the speed of rotation of the rotating grinding disks. Thus, the grinding disk according to the invention can be used for grinding of hard materials, in particular of minerals, ceramics, or hard metals. Likewise, plastics or soft metals can be ground. An additional area of application would be the grinding of particularly soft materials, e. g. of wood pulps. Likewise, the disk mill according to the invention is suitable for the grinding of foodstuffs of any type, thus also of spices for the food industry.

### BRIEF DESCRIPTION OF THE DRAWINGS

Reference will now be made to the accompanying drawings, wherein:

FIG. 1 is a schematic side view, partly sectioned, showing an embodiment example of a disk mill according to the invention,

FIG. 2 is a sectioned side view, schematically and partially in detail, showing the two grinding disks of the disk mill from FIG. 1 with the outer edge section of working surfaces running parallel to one another,

FIG. 3 is a schematic plan view, enlarged, showing one of the two grinding disks with cutting teeth disposed there, and

FIG. 4 is a cross section, enlarged and in part, showing the saw-tooth configuration of the cutting teeth.

### DETAILED DESCRIPTION OF THE INVENTION

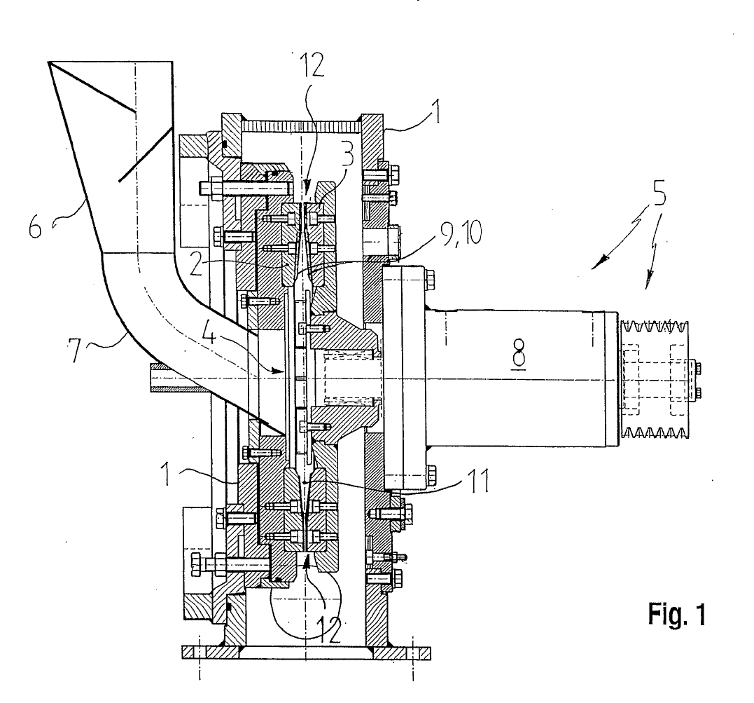

FIG. 1 shows an embodiment example of a disk mill according to the invention in schematic side view. For better understanding, at this point let reference be made once again to DE 102 03 752 C1, which explains the individual component parts of the disk mill.

The disk mill 1 comprises, as essential components, a housing 1 with annular grinding disks 2,3 disposed therein, where the grinding disk 2 is implemented in such a manner that it cannot rotate and the grinding disk 3 is implemented in such a manner that it can rotate. Both grinding disks 2, 3 are disposed so as to be essentially parallel to one another and comprise a central hole 4, which in the case of the stationary grinding disk 2 which cannot rotate serves to receive the grinding stock via an intake hopper 6 and in the case of grinding disk 3 which can rotate serves for coupling to a drive 7 via a bearing 8.

Both grinding disks 2, 3 comprise working surfaces 9, 10 directed towards one another which together form a working space 11. From the central hole 4 the working space narrows in the outwards direction due to the contour of the working surface 9, 10 so that when grinding disk 3 is rotating the grinding stock moves in the outwards direction due to the centrifugal forces occurring and, due to the reduced working space there, is reduced in the size of its pieces or ground.

According to the invention, the working surfaces 9, 10 are formed in an outer edge section 12 so as to be parallel to one another and with at least a slight spacing from one another. In other words, the working surfaces 9, 10 of the grinding disks 2, 3 run from a central area or from the central hole 4 in the outwards direction towards one another and in so doing narrow the working area 11. In the outer edge section 12 the working surfaces 9, 10 lie opposite one another with the slightest spacing from one another and in fact with at least substantially parallel alignment. At this point let it be noted that the working surfaces 9, 10 do not necessarily have to run parallel to one another at the outer edge section 12. It is also conceivable that they continue to approach one another in the outwards direction but to a lesser degree than in the actual working space 11 in which the working surfaces 9, 10 run at a significant inclination to one another in the outwards direction.

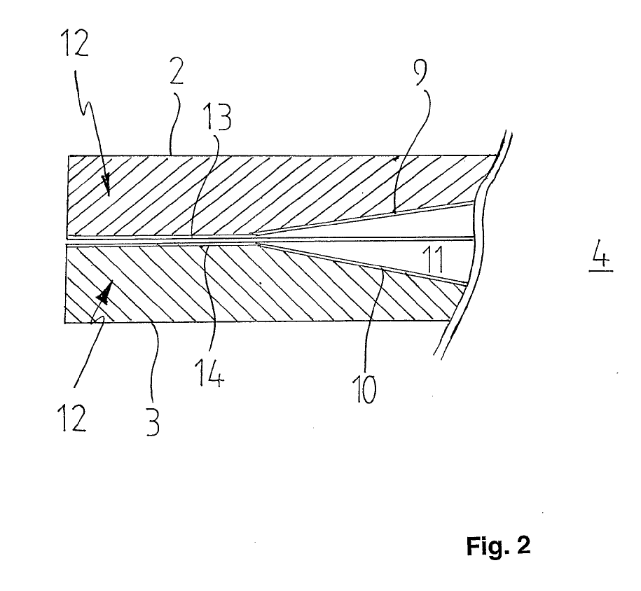

FIG. 2 shows in detail the two grinding disks 2, 3 with their respective working surfaces 9, 10 and the central hole 4. The working space 11 is formed by the working surfaces 9, 10, where the working surfaces 9, 10 are disposed at the outer edge section 12 so as to be parallel to one another and with the slightest spacing from one another. In this circular, flat area the grinding stock dwells in any case significantly longer than in a linear area formed as a circle of minimal diameter.

In relation to FIG. 1 let it be noted that the grinding disk 2 is formed so that it cannot rotate and the grinding disk 3 is formed so that it can rotate. Furthermore, FIG. 1 allows it to be seen that the grinding disks 2, 3 are disposed so as to be coaxial with respect to one another and of approximately equal size. Accordingly, the working surfaces 9, 10 of the grinding disks 2, 3 are made to be of the same size.

FIGS. 1 and 2 together allow it to be seen that the edge section 12 enclosing the working surfaces 13, 14 running parallel to one another has the form of a ring and is formed therein to be a flat surface. The working surfaces 13, 14 running parallel to one another can be dimensioned in such a manner that the edge section 12 enclosing these working surfaces 13, 14 can make up 30% to 70% of the radial extension of the grinding disks 2, 3.

Furthermore, FIGS. 1 and 2 show that in the area of the working space 11 narrowing in the outwards direction the working surfaces 9, 10 run conically towards one another. A different type of structure, e. g. in steps, can also be realized.

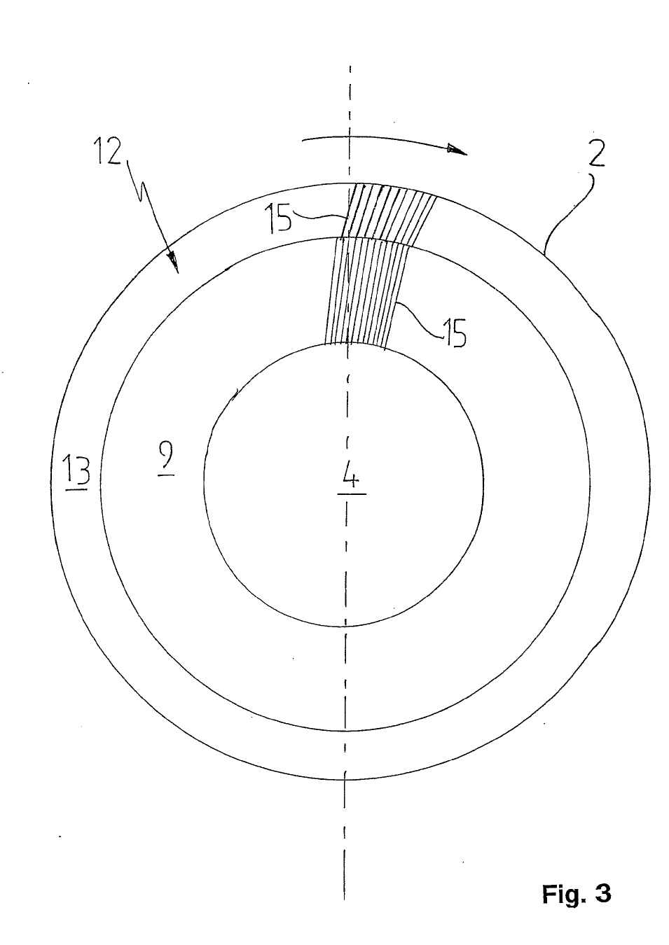

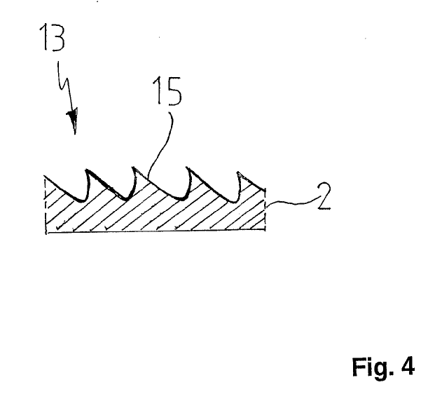

Together, FIGS. 3 and 4 show that the working surface 9, 10 and/or 13, 14 of at least one of the grinding disks 2, 3 is provided with cutting teeth 15. In the case of the embodiment example represented here both grinding disks 2, 3 are provided in all the areas of the working space 11, i. e. in all the areas of the working surface 9, 10 and 13, 14, with cutting teeth 15, where the cutting teeth 15 can have any cross-sectional form. In a particularly advantageous manner they are implemented in cross section approximately in the manner of a saw tooth.

FIG. 3 shows a grinding disk 2, 3 in schematic plan view, where the working surface 9 running conically towards one another and the working surface 13 running in parallel can be seen. Both surfaces 9, 13 are provided with cutting teeth 15 whose longitudinal extension deviates from radial alignment in both areas. Furthermore, FIG. 3 shows that the cutting teeth 15 extend in both areas at different angles to the radial alignment in order namely to lengthen the dwell time in the outer edge section 12 and thus to enhance the result of grinding.

As already mentioned in the general part of the description, the cutting teeth 15 can be structured differently in cross section. Of quite particular advantage is a saw-tooth cross section, as can be inferred from the detail drawing of FIG. 4. Thus, FIG. 4 shows a cross section through several cutting teeth 15 formed so as to be adjacent to one another, said cross section allowing the saw-tooth character of each one of the cutting teeth 15 to be seen. In regard to additional features reference will be made to the general part of the description to avoid repetitions, in particular in reference to features which cannot be related to FIG. 4, or can be related to it only in a subordinate manner.

Finally let it be noted that the embodiment example discussed above serves for the exemplary explanation of the claimed teaching but does not restrict it to the embodiment example.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A disk mill comprising two grindings disks each formed as a ring with a central hole, with the disks being disposed so as to be essentially parallel to one another, and rotatable with respect to one another about a common axis which extends through the central holes of the disks, and which comprise:
first working surfaces in an inner area which are directed towards one another, are spaced apart from one another thereby forming a working space in the area of the hole, run conically towards one another in the outwards direction, and narrow the working space; and
second working surfaces formed in an outer edge section so as to be parallel to one another and with at least slight spacing from one another, wherein the first working surfaces as well as the second working surfaces are provided with straight cutting teeth, wherein the cutting teeth have an approximately saw-tooth cross section, wherein the cutting teeth of the first and second working surfaces of the same grinding disk run in the same direction obliquely to the radial direction, and wherein the cutting teeth of the second working surfaces are inclined more sharply than the cutting teeth of the first working surfaces.

2-13. (canceled)

14-23. (canceled)

24. The disk mill according to claim 1, wherein one of the two grinding disks is mounted in such a manner that it cannot rotate and the other grinding disk is mounted in such a manner that it can rotate.

25. The disk mill according to claim 1, wherein the two grinding disks are mounted in such a manner that they can rotate counter to one another.

26. The disk mill according to claim 1, wherein the grinding disks are disposed so as to be coaxial with each other.

27. The disk mill according to claim 1, wherein the grinding disks are disposed so as to be eccentric with respect to one another.

28. The disk mill according to claim 1, wherein the grinding disks are approximately of equal size.

29. The disk mill according to claim 28, wherein the grinding disks have approximately equal working surfaces.

30. The disk mill according to claim 1, wherein the outer edge section is formed as a ring.

31. The disk mill according to claim 1, wherein the outer edge section makes up approximately 30% to 70% of a radial extension of the grinding disks (2, 3).

32. The disk mill according to claim 1, wherein the cutting teeth are at an angle of approximately 2° to 40° relative to a radial direction.

33. The disk mill according to claim 1, wherein said disk mill is configured for grinding hard materials.

34. The disk mill according to claim 33, wherein said disk mill is configured for grinding at least one of minerals, ceramics, or hard metals.

35. The disk mill according to claim 1, wherein said disk mill is configured for grinding at least one of plastics or soft metals.

36. The disk mill according to claim 1, wherein said disk mill is configured for use grinding soft materials.

37. The disk mill according to claim 36, wherein said disk mill is configured for grinding wood pulps.

38. The disk mill according to claim 1, wherein said disk mill is configured for grinding foodstuffs.
